(19) United States
(12) Patent Application Publication
(10) Pub. No.: US 2008/0028561 A1
(43) Pub. Date: Feb. 7, 2008

(54) Readily replaceable and disposable paint roller covers

(76) Inventor: Antonio C. Ros, Virginia Beach, VA (US)

Correspondence Address: JAMES RAY & ASSOCIATES, 2640 PITCAIRN ROAD, MONROEVILLE, PA, 15146, US

(21) Appl. No.: 11/881,697

(22) Filed: Jul. 27, 2007

Related U.S. Application Data
(60) Provisional application No. 60/834,896, filed on Aug. 1, 2006.

(51) Int. Cl. B05C 17/02

(52) U.S. Cl. 15/230.11

(57) ABSTRACT

An apparatus for applying paint includes a hollow solid cylinder which is supported on and freely rotates around the axle portion of a rigid bent-rod frame with a handle disposed on one end. A replaceable and disposable self-adhering absorbent pad is removably wrapped around and stuck to the outer surface of the hollow cylinder.

### CROSS REFERENCE TO RELATED APPLICATION

This patent application is related to and claims priority from U.S. Provisional Patent Application Ser. No. 60/834,896 filed Aug. 1, 2006.

### FIELD OF THE INVENTION

The present invention relates, in general, to devices for applying paint and, more particularly, this invention relates to paint rollers with readily replaceable and disposable absorbent roller covers.

### BACKGROUND OF THE INVENTION

Prior to the conception and development of the present invention, paint roller covers were frequently cleaned by laborious soaking and rinsing in water accompanied by squeezing out diluted paint. Removing the covers and throwing them away is an option, but removal is a very messy job that gets paint onto one's hands and elsewhere. If the paint is allowed to dry, removing the cover from the roller assembly can be very difficult.

### SUMMARY OF THE INVENTION

The present invention provides an apparatus for applying paint which includes a hollow solid cylinder which is supported on and freely rotates around the axle portion of a rigid bent-rod frame with a handle disposed on one end. A replaceable and disposable self-adhering absorbent roller cover is removably wrapped around and stuck to the outer surface of the hollow cylinder. In an alternative embodiment of the invention, the hollow cylinder is adaptable to a common bow-spring type of paint roller holder. An option for the absorbent roller covers is a corner pull tab or loop to facilitate removal for disposal.

### OBJECTS OF THE INVENTION

It is, therefore, one of the primary objects of the present invention to provide an inexpensive paint roller cover that can be easily replaced and thrown away eliminating any cleaning of the roller cover.

Another object of the present invention is to provide a disposable paint roller cover in an assembly that adapts readily to common paint rollers.

An additional object of the present invention is to provide disposable paint roller covers wherein a plurality of them can be compactly stored.

In addition to the various objects and advantages of the present invention described with some degree of specificity above, it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a perspective view of steps in deployment of the apparatus for applying paint as taught in the present invention.

FIG. 2 is a perspective view of a deployment of the paint application apparatus on a common paint roller holder in accordance with the teachings of the present invention.

### DETAILED DESCRIPTION OF A PRESENTLY PREFERRED AND AN ALTERNATIVE EMBODIMENT OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

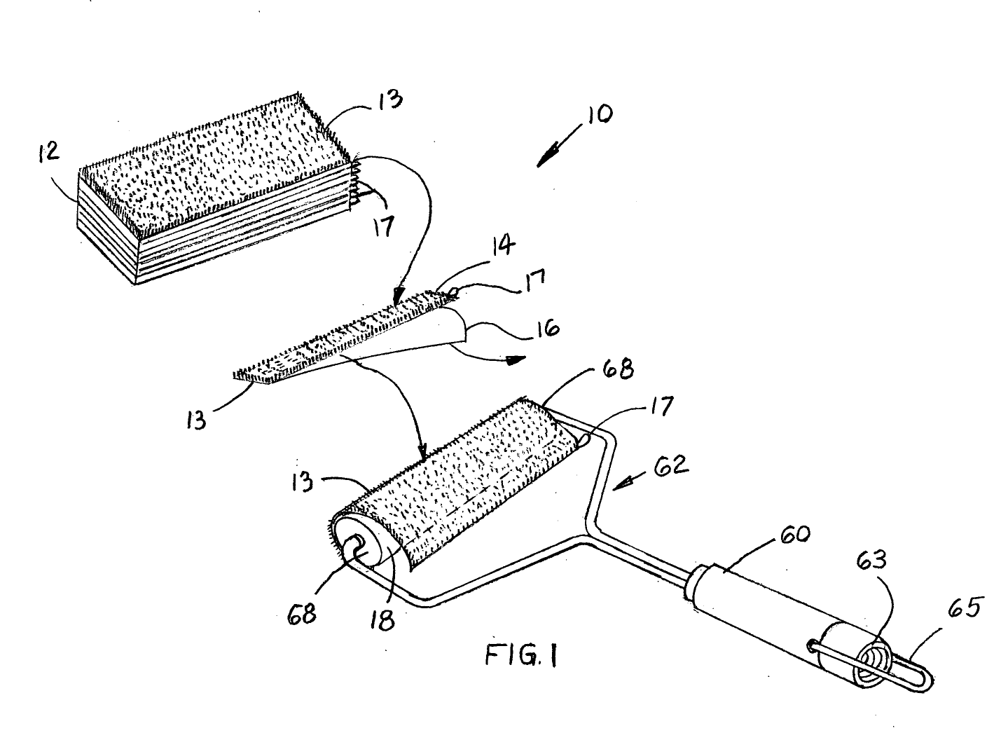

Referring initially to FIG. 1, the novel apparatus for paint application 10 and the steps in using the present invention are illustrated. The self adhering paint roller covers 13 are sold flat as a plurality in a compact stack 12, typically boxed. To prepare a roller for painting, one roller cover pad 13 is removed from the stack 12, commonly with the aid of an optional pull tab 17 on one corner of the roller cover pad 13. One side of a paint pad 13 is a soft absorbent material 14 typically about 5 to 10 mm thick. The material may be any of those commonly used for paint roller covers. The back side opposite the absorbent material of the paint roller cover is coated with an adhesive, and protected with a peelable film 16. The adhesive will most likely be one that is pressure sensitive, similar to what is used on masking tape and peelable labels. The protective film 16 is peeled from the sticky surface, and the roller cover 13 is then pressed onto the cylinder 18 of a paint roller. The cylinder 18 has bushings 68 at either end which hold the cylinder 18 snugly and allows rotation around the axle ends of the bent rods 62. A padded grip handle 60 is at the other end of the roller assembly. The interior end of the handle 63 optionally is threaded to receive a handle extension. Another option is a hanging loop 65 at the end of the handle 60. When the user is done painting, the pull tab or loop 17 is located and pulled away from the cylinder 18 to unwrap the roller cover or pad 13 from the cylinder 18. The roller cover 13 is then discarded.

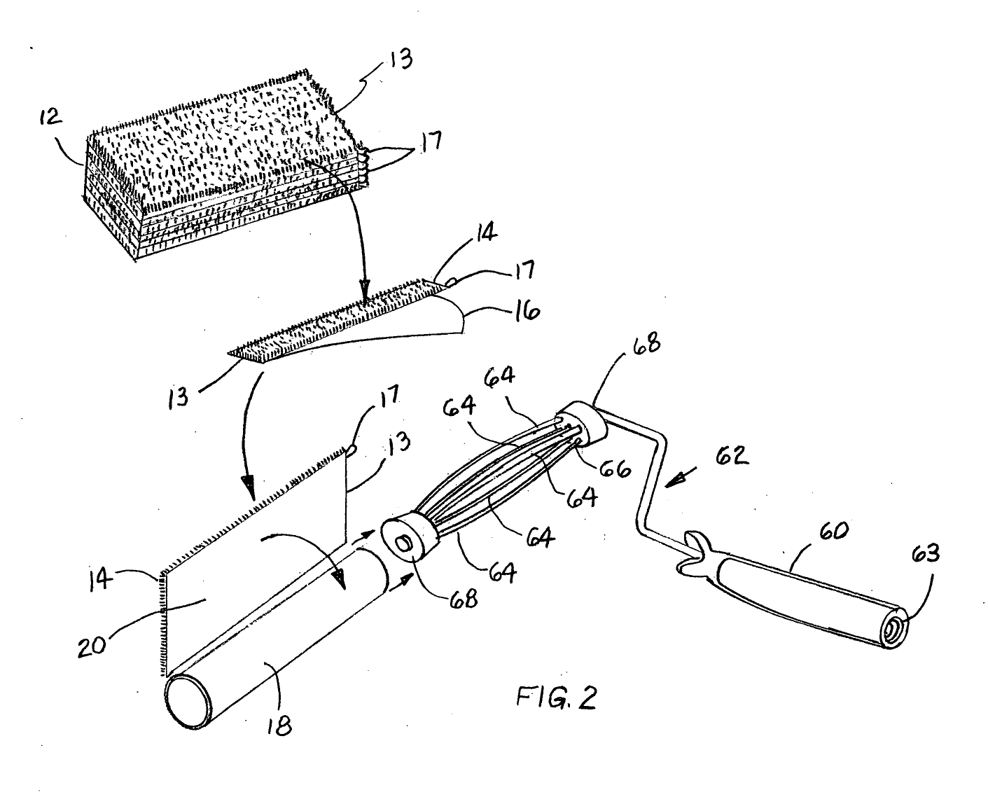

FIG. 2 illustrates a similar, but more economical embodiment of the invention. A rigid plastic or cardboard hollow cylinder 18 with a substantially smooth and solid surface is adaptable for a tight fit over a common bow-spring type roller holder 62. A plurality of bow springs 64 are imbedded at each end into the bushings 68 with a central axle 66, which is an extension of the bent rod 62. A handle portion 60 makes up the remainder of the common roller holder. The interior end of the handle 63 optionally is threaded to receive a handle extension. The disposable paint roller covers or pads 13 are sold or supplied in a stack 12. To prepare a roller for painting, a roller cover pad 13 is removed from the stack 12, and the protective film 16 covering the adhesive backing on the roller cover pad 13 is removed. The entire outer surface of the cylinder 18 is then wrapped with the self adhesive pad 13. The cylinder 18 with the roller pad 13 wrapped around and stuck to it is then slid into place over the bushings 68 and the bow springs 64. When the user is done painting, the absorbent roller cover pad 13 is removed from the cylinder 18 with the aid of the pull tab 17. The pad and any residual paint are then discarded in the trash.

While a presently preferred and an alternative embodiment of the present invention have been described in sufficient detail above to enable a person skilled in the relevant art to make and use the same, it should be obvious that various other adaptations and modifications can be envisioned by those persons skilled in such art without departing from either the spirit of the invention or the scope of the appended claims.

I claim:

1. An apparatus for applying paint comprising:
a) a hollow cylinder of a preselected material;
b) a substantially rigid bent-rod frame with a handle disposed on one end and at least one distal end forming an axle for said hollow cylinder;
c) a rotation-assistance means disposed along said at least one end forming an axle for supporting and enabling easy rotation of said hollow cylinder on said axle; and
d) a replaceable self-adhering absorbent roller cover with predetermined length, predetermined width, and predetermined thickness.

2. The apparatus for applying paint, according to claim 1, wherein said rotation-assistance means are bushing inserts with central apertures, said bushing inserts tightly fitting into ends of said hollow cylinder.

3. The apparatus for applying paint, according to claim 1, wherein said replaceable self-adhering absorbent roller cover has one of a tab and a loop disposed on at least one corner to facilitate removal.

4. The apparatus for applying paint, according to claim 1, wherein said predetermined length of said self-adhering absorbent roller cover is between about 4 and 30 centimeters.

5. The apparatus for applying paint, according to claim 1, wherein said predetermined thickness of said self adhering absorbent roller cover is between about 3 and 12 millimeters.

6. The apparatus for applying paint, according to claim 1, wherein said predetermined width of said self adhering absorbent roller cover is between about 3 and 40 centimeters.

7. The apparatus for applying paint, according to claim 1, wherein said preselected material of said hollow cylinder is a substantially rigid smooth plastic.

8. The apparatus for applying paint, according to claim 1, wherein said preselected material of said hollow cylinder is a substantially flexible plastic.

9. In combination with a conventional paint roller holder, the improvement comprising:
a) a hollow cylinder adaptable to properly fit a typical paint roller holder; and
b) a replaceable and disposable self-adhering absorbent roller cover with a predetermined thickness.

10. The improvement, according to claim 9, wherein said replaceable self-adhering absorbent roller cover has one of a pull tab and loop positioned on at least one corner for easy removal.

11. The improvement, according to claim 9, wherein said predetermined thickness of said self adhering absorbent roller cover is between about 3 and 12 millimeters.

12. The improvement, according to claim 9, wherein said preselected material of said hollow cylinder is a substantially rigid smooth plastic.

13. The improvement, according to claim 9, wherein said preselected material of said hollow cylinder is a substantially rigid textured plastic.
